(19) United States
(12) Patent Application Publication
(10) Pub. No.: US 2016/0146592 A1
(43) Pub. Date: May 26, 2016

(54) SPATIAL MOTION SENSING DEVICE AND SPATIAL MOTION SENSING METHOD

(71) Applicant: AVerMedia TECHNOLOGIES, INC., NEW TAIPEI CITY (TW)

(72) Inventors: Chi-Hsiung WANG, New Taipei City (TW); Jui-Hung KAO, New Taipei City (TW)

(21) Appl. No.: 14/936,695

(22) Filed: Nov. 10, 2015

(30) Foreign Application Priority Data
Nov. 24, 2014 (TW) 103140642

(51) Int. Cl. G01B 11/00; G01J 1/04

(52) U.S. Cl. CPC G01B 11/00; G01J 1/0429; G01J 1/0474; G01J 1/0414

(57) ABSTRACT

A spatial motion sensing device and a spatial motion sensing method are provided. The spatial motion sensing device includes an image sensing device, a lens, a diffuser, a reference light source, and an image processor. The diffuser is disposed between the image sensing device and the lens. The reference light source is configured for providing a reference light to the diffuser, and the diffuser guides the reference light to the image sensing device. The lens is configured for imaging scenery onto the diffuser to form an image. The image sensing device receives the optical information of the image and the reference light. The image processor is electrically connected to the image sensing device for analyzing the optical information.

### RELATED APPLICATIONS

This application claims priority to Taiwanese Application Serial Number 103140642, filed Nov. 24, 2014, which is herein incorporated by reference.

### BACKGROUND

1. Field of Disclosure

The present disclosure relates to a spatial motion sensing technique, and particularly to a spatial motion sensing device and a spatial motion sensing method.

2. Description of Related Art

With booming development of electronics, operating elements used for inputting instructions becomes an indispensable peripheral device. The operating element can perform an operating procedure on a designated object according to an action or gesture variation of a user. Based on different types of operation modes, the currently widely applied operation element is a mouse, a wireless air mouse, a motion controller, and the like.

A general mouse moves on a surface to determine a steering direction and distance thereof, and thus the input in a three-dimensional space cannot be analyzed. The wireless air mouse is a device with a built-in gyroscope or gravity sensor, which feeds back actions of a user based on the inertial motion and angular velocity of the gyroscope or gravity sensor. However, variation of such an inertial motion or angular velocity is not controlled intuitively.

Furthermore, the motion controller reckons the motion of the object to be tested by detecting the appearance variation of the object. A general motion controller projects an infrared light onto an object, and then uses a sensor to sense the infrared light reflected by the object, so as to analyze the motion condition of the object over time. However, since the infrared light projected onto the object has different projection statuses due to different distances or angles, and also the infrared light weakens as the projecting distance is increased, an optimal sensing range is formed. Departing from the sensing range, the sensing efficiency is reduced or the sensing is failed. Moreover, a larger power is needed for projecting the infrared light clearly into the space, and thus too much energy consumption is caused.

In view of the above, due to inconvenience still exists in various operating elements, it is a direction of efforts in the industry currently how to design an operating element which can solve the aforementioned disadvantages.

### SUMMARY

The present disclosure provides a spatial motion sensing device, including an image sensing device, a lens, a diffuser, a reference light source, and an image processor. The diffuser is disposed between the image sensing device and the lens. The reference light source is configured for providing a reference light to the diffuser, and the diffuser guides the reference light to the image sensing device. The lens is configured for imaging scenery onto the diffuser to form an image. The image sensing device receives the optical information of the image and the reference light. The image processor is electrically connected to the image sensing device for analyzing the optical information of the image and the reference light as received by the image sensing device.

The present disclosure further provides a spatial motion sensing method, including the following operations: imaging scenery through a lens onto a diffuser to form an image. A reference light is provided onto the diffuser. Optical information of the image of the diffuser and the reference light is sensed. The sensed optical information of the image and the reference light is analyzed.

Since the spatial motion sensing device and spatial motion sensing method of the present disclosure image scenery in a space through a lens onto a diffuser, under the presence of the architecture of the present disclosure the image formed on the diffuser and the reference light guided by the diffuser are directly received or sensed so as to obtain the optical information of the image and the reference light. Therefore, the reference information used for image analyzing is increased, and thus the case of misjudgment of the spatial motion sensing device is reduced. Moreover, since in the present disclosure the reference light is projected onto the diffuser, rather than projected into the space (scenery), the power of the reference light does not need to be too high, which saves the energy consumption of the spatial motion sensing device.

### BRIEF DESCRIPTION OF THE DRAWINGS

FIG. 1 is a schematic view of a spatial motion sensing device according to an embodiment of the present disclosure;

FIG. 2 is a flow chart of a spatial motion sensing method according to an embodiment of the present disclosure;

FIG. 3A is a schematic view of scenery of FIG. 1 in an embodiment;

FIG. 3B is a front view of an image of the scenery of FIG. 3A formed on a diffuser;

FIG. 4 is a timing diagram of an embodiment wherein the spatial motion sensing device of FIG. 1 is applied for spatial motion sensing;

FIG. 5 is a schematic side view of an embodiment of the diffuser of FIG. 1;

FIG. 6 is a schematic side view of another embodiment of the diffuser of FIG. 1;

FIG. 7 is a schematic view of a spatial motion sensing device according to an embodiment of the present disclosure which is applied to a controller and scenery; and

FIG. 8 is a schematic view of a spatial motion sensing device according to an embodiment of the present disclosure which is applied to a mouse and main scenery.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

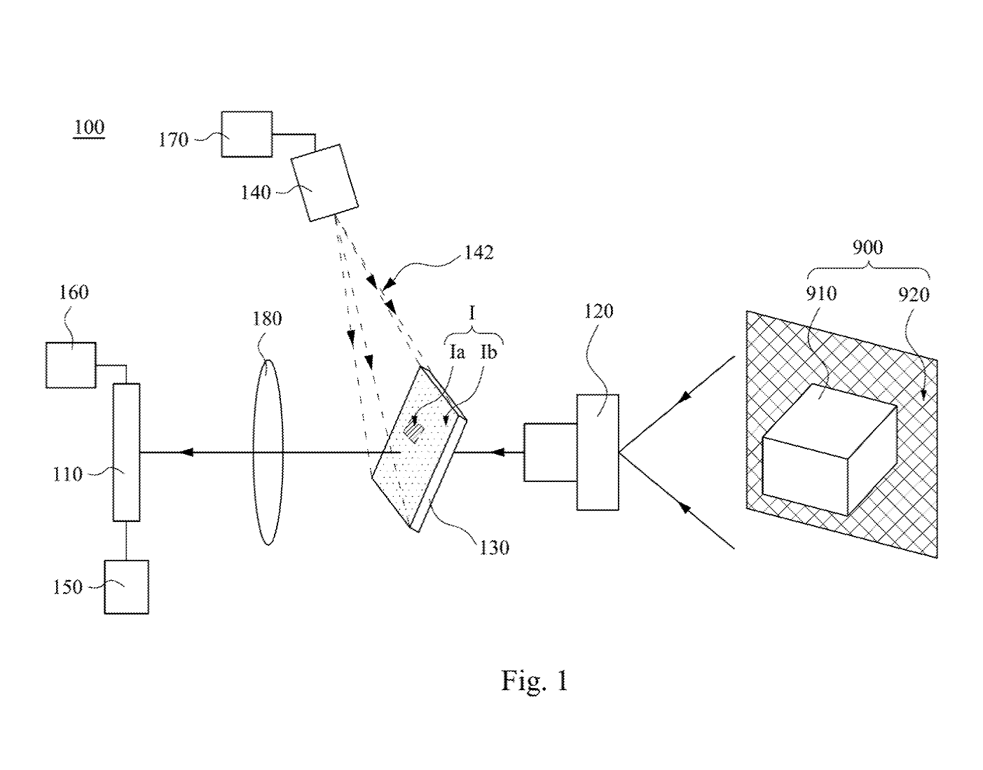

FIG. 1 is a schematic view of a spatial motion sensing device 100 according to an embodiment of the present disclosure. The spatial motion sensing device 100 includes an image sensing device 110, a lens 120, a diffuser 130, a reference light source 140, and an image processor 150. The diffuser 130 is disposed between the image sensing device 110 and the lens 120. The reference light source 140 is configured for providing a reference light 142 to the diffuser 130, and the diffuser 130 guides the reference light 142 to the image sensing device 110. The lens 120 images scenery 900 onto the diffuser 130 to form at least one image I. The image sensing device 110 receives optical information of both the reference light 142 and the image I. In this embodiment, the optical information may refer to information about brightness distribution, of course may refer to other optical information depending on actual demands, such as information about saturation distribution, and the present disclosure is not limited in this respect. The image processor 150 is electrically connected to the image sensing device 110 for analyzing the optical information of both the reference light 142 and the image I as received by the image sensing device 110, so as to obtain motion information of the spatial motion sensing device 100 relative to the scenery 900 when the motion of the spatial motion sensing device 100 starts. The motion information may be information such as a moving distance generated by the motion, a moving direction and a relative coordinate after the motion, or other feature information obtained from the motion (e.g., motions such as rotation or vibration), which are all included in the scope of the present disclosure.

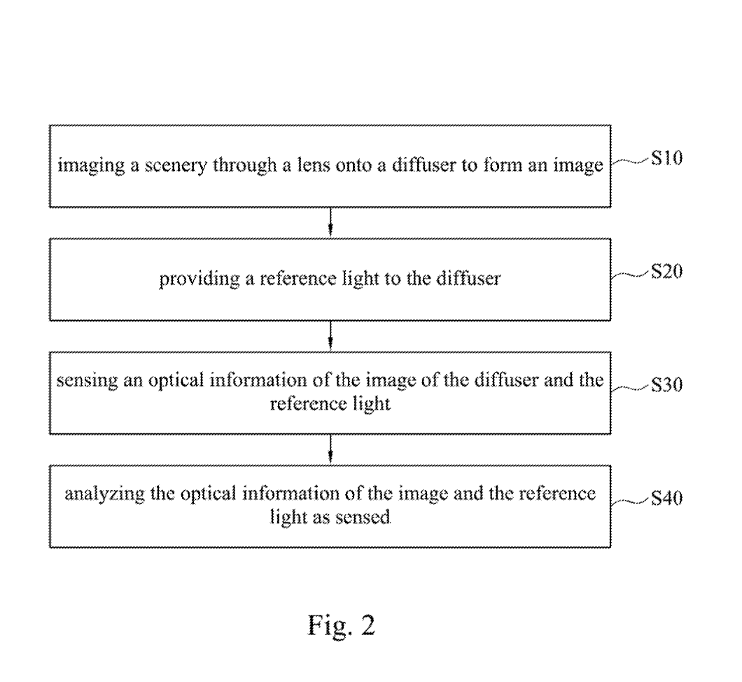

In operation, also referring to FIG. 2, which is a flow chart of a spatial motion sensing method according to an embodiment of the present disclosure. As shown in operation S10, the scenery 900 is imaged through a lens 120 onto a diffuser 130 to form an image I. More specifically, the lens 120 can image the scenery 900 in the space onto the diffuser 130, i.e., converting N-dimensional information into N-1-dimensional information. In this embodiment, conversion from perspective (three-dimensional) information to plane (two-dimensional) information is taken as an example, and the present disclosure is not limited in this respect. Herein selections of the so-called three-dimensional/two-dimensional information may set different parameters depending on actual demands. For example, the three-dimensional information may refer to location information, distance information, and shape information, and the two-dimensional information may refer to the location information and the angle information, although the present disclosure is not limited in this respect. For example, taking a rectangular screen as an example, the picture generated by the screen is also a rectangular light emitting source. When the spatial motion sensing device 100 directly faces the screen, the image presented on the diffuser 130 of the spatial motion sensing device 100 is also a rectangular, but when the spatial motion sensing device 100 is angularly disposed from the screen, the image presented on the diffuser 130 is converted into a trapezoid, and thus the angle variation can be reckoned from the variation of the image shape.

Furthermore, also for example scenery 900 may be defined as including main scenery 910 and a background 920, which respectively form images Ia and Ib on the diffuser 130. For purpose of clarity, the background 920 of FIG. 1 is presented for example in a dot form, which represents other images other than the main scenery 910 in the space. When the image Ia of the main scenery 910 on the diffuser 130 varies, the spatial motion sensing device 100 can sense the variation of motion or shape size of the main scenery 910. In some embodiments, the main scenery 910 may be scenery generated by a luminous object or a light reflector, e.g. a picture generated by a television screen, a picture generated by a light source or a projecting screen, and of course probably scenery generated from an actual object or scenery corresponding to a three-dimensional image. In this embodiment, the brightness of the image Ia is higher than that of the image Ib. In some other embodiments, the main scenery 910 may be a non-luminous object, and the main scenery 910 may shield a light incoming the lens 120, and thus the brightness of the image Ia is lower than that of the image Ib.

Subsequently, as shown in operation 520, the reference light 142 is provided to the diffuser 130. More specifically, the reference light 142 may irradiate onto the entire diffuser 130, which can for example regulate the contrast or brightness of the image I. In some embodiments, the reference light 142 may be a pulsed light. That is, the reference light 142 does not irradiate continuously the diffuser 130, but rather irradiates the diffuser 130 with intervals. In this embodiment, a periodic pulsed light is taken as an example, and the present disclosure is not limited in this respect. Moreover, the reference light 142 may be a visible light (having a wavelength of about 400 to about 700 nanometers) or a near-infrared light (having a wavelength of about 700 to about 2500 nanometers), and the present disclosure is not limited in this respect.

Subsequently, as shown in operation S30, optical information of the image I of the diffuser 130 and the reference light 142 is sensed. More specifically, the diffuser 130 guides (for example, reflects) the reference light 142 to the image sensing device 110, and the image I is also sensed by the image sensing device 110, so that the image sensing device 110 can sense the optical information of both the image I and the reference light 142 on the diffuser 130. The information is, but not limiting to, the brightness distribution or saturation distribution. In some embodiments, if the reference light 142 is a pulsed light, the image sensing device 110 can sense brightness distributions with and without the reference light 142 in sequence, which can increase the identification ability of the image Ib corresponding to the background 920.

In this embodiment, the image sensing device 110 may be an array of photovoltaic conversion elements (not shown). The photovoltaic conversion element can convert light energy into electrical signals. When the light intensity of the light irradiating the photovoltaic conversion element is stronger, the electrical signal is stronger, and vice versa. Therefore, when the image sensing device 110 senses the image I and the reference light 142, the light intensity of a light received by each photovoltaic conversion element varies, so that the optical information on the diffuser 130 at that sensing time can be obtained.

Subsequently, as shown in operation S40, the optical information of image I and the reference light 142 as sensed (by the image sensing device 110) is analyzed. More specifically, based on variation of motion direction and size of the image Ia corresponding to the main scenery 910 on the diffuser 130, the image processor 150 can determine the motion direction of the main scenery 910 in the space. For example, the motion of the image Ia on the diffuser 130 corresponds to a planar motion of the main scenery 910 in the space, while the size variation of the image Ia on the diffuser 130 corresponds to the distance variation of the main scenery 910 in the space. For example, size reduction represents that the main scenery 910 goes away from the spatial motion sensing device 100, while size enlargement represents that the main scenery 910 approaches the spatial motion sensing device 100. In view of the above examples, by analyzing the aforementioned optical information, the motion information of the spatial motion sensing device 100 relative to the scenery 900 can be obtained for subsequent application. However, the aforementioned analyzing methods are only illustrative, and are not meant to limit the present disclosure. Analyzing manners and matched algorithms can be selected flexibly according to actual demands by those of ordinary skills in the art.

In view of the above, since the spatial motion sensing device 100 and spatial motion sensing method of the present disclosure image scenery 900 in a space through a lens 120 onto a diffuser 130, under the presence of the architecture of the present disclosure the image I formed from the diffuser 130 and the reference light 142 guided by the diffuser 130 are directly received or sensed so as to obtain the optical information of the image I and the reference light 142. Therefore, the reference information used for image analyzing is increased, and thus the case that the spatial motion sensing device 100 misjudges is reduced. Moreover, since in this embodiment the reference light 142 is projected onto the diffuser 130, rather than projected into the space (scenery 900), the power of the reference light does not need to be too high, which saves the energy consumption of the spatial motion sensing device 100.

Reference is made back to FIG. 1. In some embodiments, the spatial motion sensing device 100 further includes a first clock 160 which electrically connected to the image sensing device 110 The first clock 160 controls a sampling frequency of the image sensing device 110. For example, the sampling frequency may be 60 Hz. That is, the image sensing device 110 can sense (sample) for 60 times per second. However, the present disclosure is not limited in this respect. Moreover, the spatial motion sensing device 100 may further include a second clock 170 which is electrically connected to the reference light source 140. The second clock 170 controls a light-emitting frequency of the reference light source 140. That is, the reference light 142 may be a pulsed light, and the light-emitting frequency is a frequency of the pulsed light. In this embodiment, the reference light 142 is, but not limiting to, a periodic pulsed light.

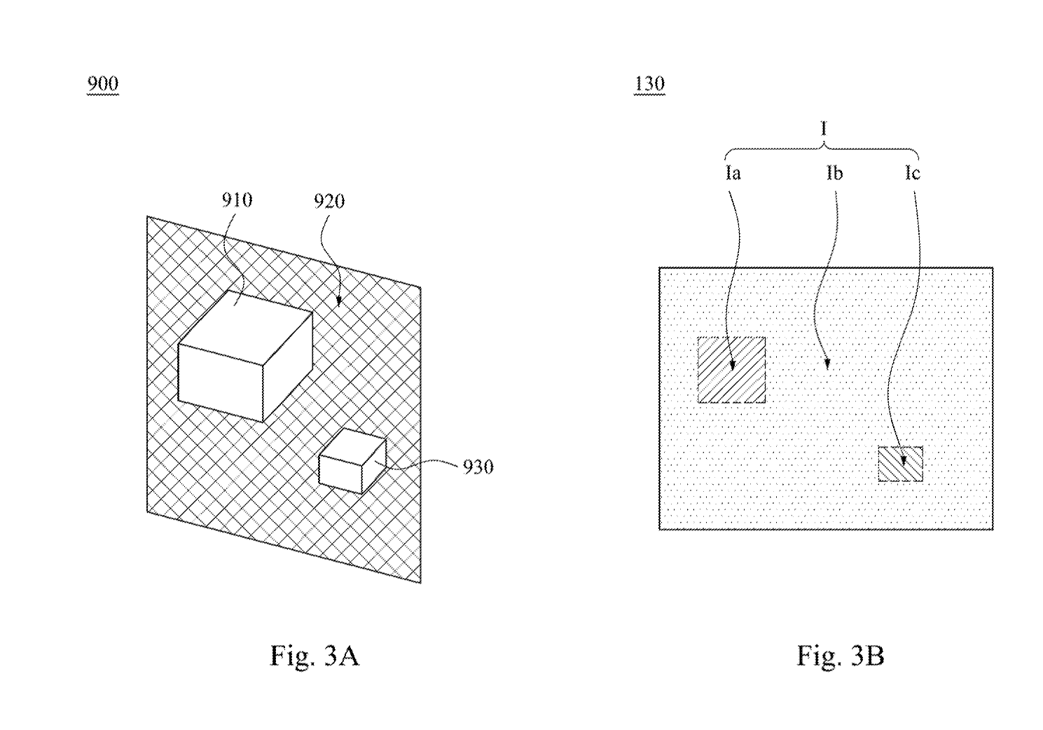

The aforementioned setting is beneficial for increasing the accuracy of the spatial motion sensing device 100. For example, reference is made to FIGS. 3A and 3B, wherein FIG. 3A is a schematic view of the scenery 900 of FIG. 1 in an embodiment, and FIG. 3B is a front view of an image I of the scenery 900 of FIG. 3A formed on the diffuser 130. In this embodiment, the scenery 900 further includes interference scenery 930, and the background 920 are for example presented in a dot form, which represents other scenery other than the main scenery 910 and the interference scenery 930 in the space. The interference scenery 930 forms an image Ic on the diffuser 130. For the purpose of clarity, the images Ia and Ic of FIG. 3B appropriately depicts front outlines of the main scenery 910 and the interference scenery 930 respectively, and the image distortion of the main scenery 910 and the interference scenery 930 projected on the diffuser 130 are omitted. The interference scenery 930 for example has a surface capable of reflecting the light, and the brightness of the image Ic corresponding to the interference scenery 930 is between the brightness of the images Ia and Ib. Therefore, the image processor 150 of FIG. 1 may misjudge the image Ic as the major object to be analyzed, and this problem can be solved by applying the aforementioned settings.

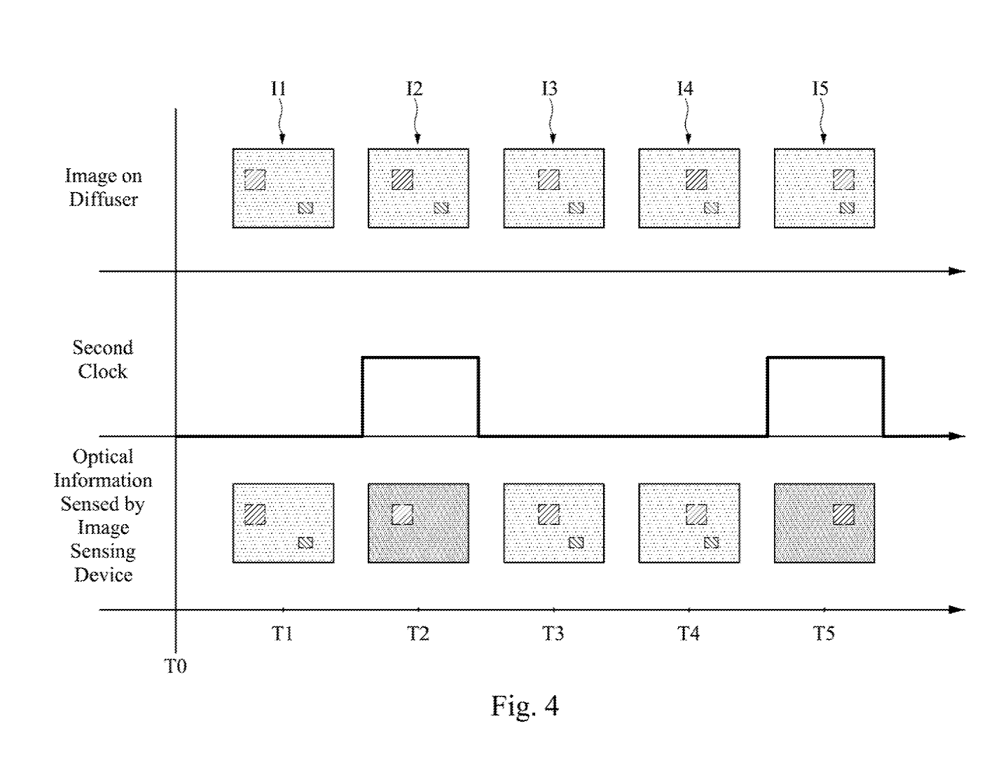

In particular, reference is made to FIGS. 1, 3B, and 4, wherein FIG. 4 is a timing diagram where the spatial motion sensing device 100 of FIG. 1 is applied for spatial motion sensing. Taking the embodiment of FIG. 3B as an example, the image Ia moves on the diffuser 130, so that from time T1 to time T5, the image Ia moves towards the right direction of the diffuser 130. The image sensing device 110 senses for once at each time point (i.e., times T1-T5). If the times T1-T5 is one second, the sampling frequency of the first clock 160 is 5 Hz. Furthermore, the reference light source 140 is kept in a switched off state at times T1 and T3-T4, and is switched on at times T2 and T5. Therefore the light-emitting frequency of the second clock 170 is about 1.6 Hz.

At times T1 and T3-T4, the reference light source 140 is kept in a switched off state, and thus the optical information (in this embodiment is for example the brightness distribution) sensed by the image sensing device 110 is respectively optical information of images I1, I3, and I4. At times T2 and T5, the reference light source 140 is kept in a switched on state, and the reference light source 140 can lighten the entire diffuser 130. If the brightness of both the images Ib and Ic of FIG. 3B is lower than that of the reference light 142, at times T2 and T5 images Ib and Ic become image noises, and thus the image processor 150 can easily identify the image Ia when analyzing the optical information at times T2 and T5. By further analyzing the optical information respectively obtained from the times T1-T5, it can be determined that at times T1, T3 and T4, the image Ic is not the main object to be analyzed. Additionally, the optical information respectively obtained at times T1-T5 can also be analyzed as other convex set, difference set, intersection, additives, subtracts, dividing or multiplying, so as to obtain more information. In other words, after the reference light 142 is added, the spatial motion sensing device 100 can perform main analysis of the motion statuses of the main scenery 910, and also perform additional comparative analysis between the main scenery 910 and the background 920 (interference scenery 930).

However, the aforementioned embodiments are only illustrative, and in other embodiments the sampling frequency may be lower than the light-emitting frequency. Basically, as long as the sampling timing is out of sync with the light-emitting timing (for example, the sampling frequency varies from the light-emitting frequency), or the sampling timing and the light-emitting timing have phase differences, and thus the image sensing device 110 can obtain both brightness distributions with and without the reference light 142, which are both beneficial for comparative analysis between the main scenery 910 and the background 920 (interference image 930).

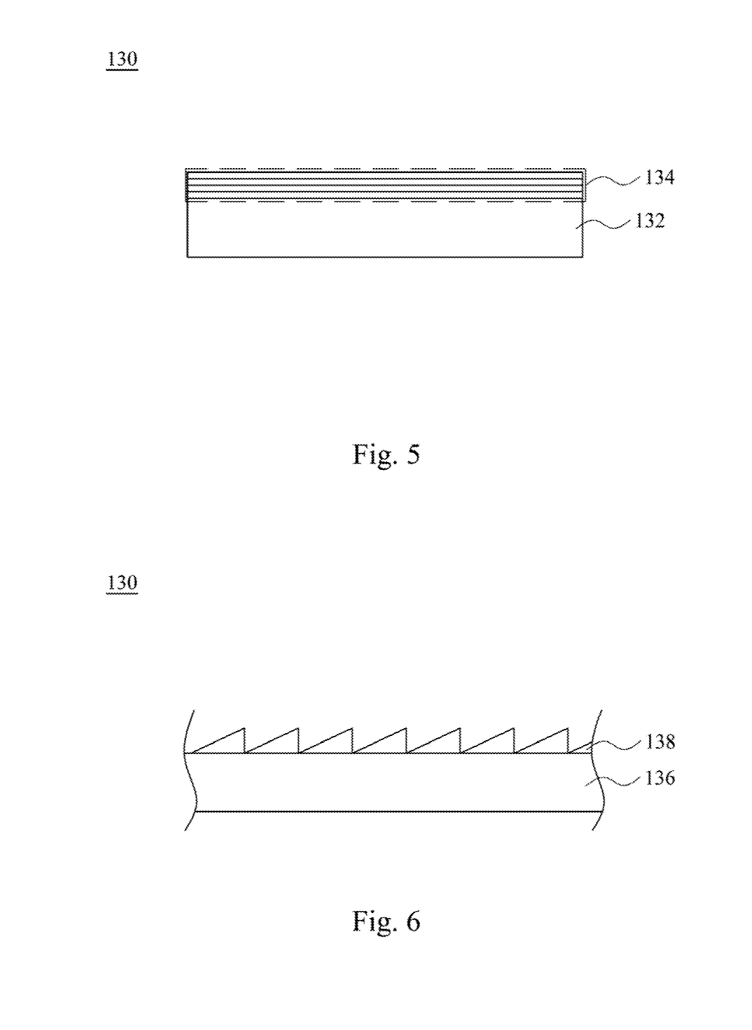

FIG. 5 is a schematic side view of an embodiment of the diffuser 130 of FIG. 1. In this embodiment, the diffuser 130 allows part of the light to pass therethrough, and allows another part of the light to be reflected. For example, the diffuser 130 may be a beam splitter or a polarizer. The beam splitter may be a band-pass, high-pass, or low-pass beam splitter, and the low-pass beam splitter for example a neutral density filter. The polarize may be a circularly or linear polarizer, and the like. Also, the diffuser 130 can be selected depending on actual demands. For example, when the main scenery 910 (see FIG. 1) is mostly generated by a liquid crystal television or liquid crystal screen, the diffuser 130 matched thereto may be a polarizer for achieving a good effect. Also, for example, when the main scenery 910 is mostly generated by a projecting screen of a projector, the diffuser 130 matched thereto may be a filter. Furthermore, for the structure of the diffuser 130, the diffuser 130 may include a transparent element 132 and a coating layer 134 present on the transparent element 132. The coating layer 134 may be a stack structure, which utilizes periodic stack of multilayer materials to generate a function which allows part of the light to passing therethrough and another part of the light to be reflected. Such a diffuser 130 can be applied to scenery 900 (see FIG. 1) with a relative high brightness contrast. For example, the main scenery 910 (see FIG. 1) may be a television screen.

FIG. 6 is a schematic side view of another embodiment of the diffuser 130 of FIG. 1, in this embodiment, the diffuser 130 may be a grating, such as a holographic grating. For example, the diffuser 130 may include a substrate 136 and a plurality of microstructures disposed in the substrate 136. The microstructures 138 may be arranged periodically, which can reflect a light with a specific wavelength or polarization direction. Such a diffuser 130 can be applied on the main scenery 910 (see FIG. 1) which emits a polarized light, such as a television screen. Moreover, in other embodiments, the microstructures 138 may be arranged as a specific structure, such that after the reference light 142 irradiates on the microstructures 138 diffraction is caused, which can form a light spot on the image sensing device 110 thereby facilitating increase of the analysis accuracy of the image processor 150.

Reference is made to FIG 1. In one or more embodiments, the reference light source 140 may be a light-emitting diode or a laser. Moreover, the spatial motion sensing device 100 may further include an optical lens 180 disposed between the image sensing device 110 and the diffuser 130. The optical lens 180 can focus the image I on the diffuser 130 onto the image sensing device 110.

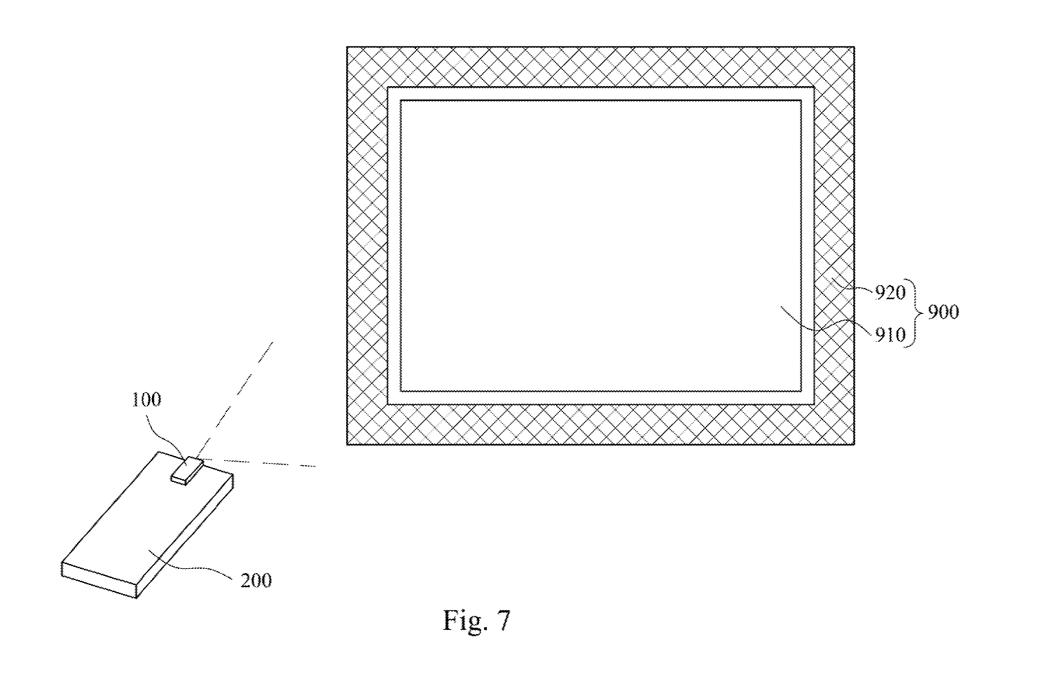

Reference is made to FIGS. 1 and 7, wherein FIG. 7 is a schematic diagram of a spatial motion sensing device 100 according to an embodiment of the present disclosure which is applied on a controller 200 and scenery 900. In this embodiment, the spatial motion sensing device 100 can be combined with the controller 200. For example, the main scenery 910 of the scenery 900 may be a picture generated by a television screen, a picture generated by a light source or projecting screen, of course may probably be scenery generated by an actual object or scenery corresponding to a three-dimensional image, of course may also be a picture generated by a smart device (such as a telephone or a tablet computer), and the present disclosure is not limited in this respect. Herein taking the main scenery 910 generated by an imaging device (screen or projector) as an example, when the controller 200 faces the main scenery 910, the main scenery 910 is imaged on the diffuser 130 of the spatial motion sensing device 100 to form the image Ia (the brightness of the image Ia is higher than that of the image Ib). Also with the motion of the controller 200, such as the motion of a user's hand held controller 200 (up, down, left and right moving or angled rotating of the controller, etc.), motion and variation (e.g., shape variation) of the image Ia are also accordingly generated on the diffuser 130, and thus the image sensing device 110 receives different optical information (such as brightness distribution or saturation distribution) of the image I over time. With calculation through the image processor 150, the spatial motion sensing device 100 can subsequently perform actions of selecting or sliding the marker of the main scenery 910 on the imaging device (screen or projector) which generates the main scenery 910 based on the gesture variation of the user. The spatial motion sensing device 100 can sense the imaging device (screen or projector) in a wired mode or a wireless mode, and the present disclosure is not limited in this respect. For example, when the user's hand held controller 200 moves towards the right direction of FIG. 7, the image corresponding to the imaging device (i.e., the main scenery 910) on the diffuser 130 of the spatial motion sensing device 100 moves towards the left direction of diffuser 130. After calculation via the image processor 150, the calculated result is fed back (through the spatial motion sensing device 100 or the controller 200) to the imaging device, such that the imaging device can control the marker on the screen so as to slide the marker toward the right direction of the screen synchronously. As such, the motion of the marker on the imaging device (such as a television, screen, projector, smart displaying device) can be controlled by utilizing the spatial motion sensing device 100 and the controller 200.

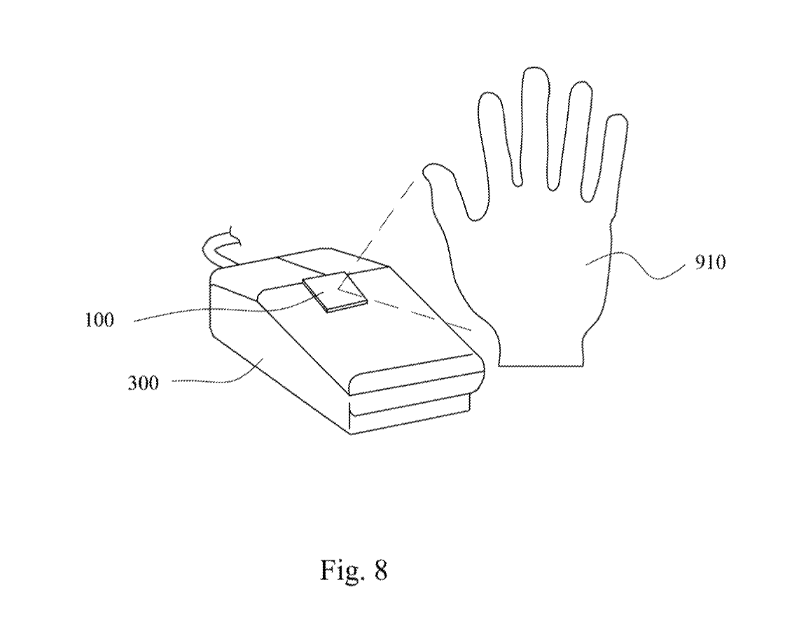

Reference is made to FIGS. 1 and 8, wherein FIG. 8 is a schematic view of a spatial motion sensing device 100 according to an embodiment of the present disclosure which is applied to an inputting element 300 and the main scenery 910. In this embodiment, the spatial motion sensing device 100 is combined with the inputting element 300 (such as a mouse), and the inputting element 300 is connected to a computer or a smart device. For example, the main scenery 910 may be the hand of the user. When a hand approaches the spatial motion sensing device 100, the hand shields part of the light incoming the spatial motion sensing device 100, and thus the hand is imaged on the diffuser 130 of the spatial motion sensing device 100 as an image Ia (the brightness of the image Ia is lower than the brightness of the image Ib). With motion or gesture varying of the hand on the diffuser 130 the image Ia also moves or changes the shape thereof, and thus the image sensing device 110 receives different optical information (such as brightness distribution) of the image I over time. With calculation through the image processor 150, the spatial motion sensing device 100 can perform actions of selecting or sliding the marker on the computer or smart device depending on the gesture variation of the user.

For example, the hand of the user moves towards the left direction of FIG. 8, and thus the image Ia also moves on the diffuser 130. After calculation through the image processor 150, the calculated result is inputted into the aforementioned computer or smart device by the inputting element 300, so as to complement the inputting procedure. Moreover, when the hand is open or bended, the area and outline of the image Ia formed corresponding to the hand vary, wherein this variation can be determined as different inputting instructions. As such, even when the hand does not directly contact the inputting element 300 (such as an operating mouse), the spatial motion sensing device 100 still can provide a corresponding inputting signal by reading the gesture variation. Furthermore, the mouse of FIG. 8 is only for illustration, but not meant to limit the present disclosure. The type of the inputting element 300 is selected flexibly by those of ordinary skills depending on actual demands.

Therefore, in the applications of FIGS. 7 and 8, the spatial motion sensing device 100 determines the motion trace of the image Ia directly based on the variation of motion and size of the image Ia on the diffuser 130. Compared with a conventional controller which uses a gyroscope or a gravity sensor, the spatial motion sensing device 100 according to the aforementioned embodiment is used more intuitively. Furthermore, since the spatial motion sensing device 100 does not need to provide an additional infrared light irradiated onto the main scenery 910, the power consumption of the spatial motion sensing device 100 itself is reduced, and also no limitation exists for the option sensing distance of the infrared light.

In view of the above, since the spatial motion sensing device of the present disclosure images scenery in a space through a lens onto a diffuser, under the presence of the architecture of the present disclosure the image formed from the diffuser and the reference light guided by the diffuser are directly received or sensed so as to obtain the optical information of the image and the reference light. Therefore, the reference information used for image analyzing is increased, and thus the case of misjudgment of the spatial motion sensing device is reduced. Moreover, since the reference light is projected onto the diffuser, rather than projected into the space (scenery), the power of the reference light does not need to be too high, which saves the energy consumption of the spatial motion sensing device. In some embodiments, a reference light having a light spot is beneficial for increasing the analysis accuracy of the image processor. Compared with a conventional controller which uses a gyroscope or a gravity sensor, the spatial motion sensing device according to various embodiments is used more intuitively.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A spatial motion sensing device, comprising:
an image sensing device;
a lens;
a diffuser disposed between the image sensing device and the lens;
reference light source providing a reference light to the diffuser, and the diffuser guiding the reference light to the image sensing device, wherein the lens images a scenery onto the diffuser to form an image, and the image sensing device receives an optical information of the image and the reference light; and
an image processor electrically connected to the image sensing device for analyzing the optical information of the image and the reference light as received by the image sensing device.

2. The spatial motion sensing device of claim 1, wherein the optical information is a brightness distribution or a saturation distribution.

3. The spatial motion sensing device of claim 1, wherein the diffuser is a beam splitter or a polarizer.

4. The spatial motion sensing device of claim 1, wherein the diffuser is a grating.

5. The spatial motion sensing device of claim 1, further comprising:
a first dock electrically connected to the image sensing device for controlling a sampling frequency of the image sensing device.

6. The spatial motion sensing device of claim 1, further comprising:
a second clock electrically connected to the reference light source for controlling a light-emitting frequency of the reference light source such that the reference light is a pulsed light.

7. The spatial motion sensing device of claim 1, further comprising:
a lens disposed between the image sensing device and the diffuser.

8. The spatial motion sensing device of claim 1, wherein the reference light is a near-infrared light or a visible light.

9. The spatial motion sensing device of claim 1, wherein the image processor analyzes the optical information to obtain motion information of the spatial motion sensing device relative to the scenery.

10. A spatial motion sensing method, comprising:
imaging a scenery through a lens onto a diffuser to form an image;
providing a reference light to the diffuser;
sensing an optical information of the image of the diffuser and the reference light; and
analyzing the optical information of the image and the reference light as sensed.

11. The spatial motion sensing method of claim 10, further comprising:
controlling a light-emitting frequency of the reference light, such that the reference light is a pulsed light.

12. The spatial motion sensing method of claim 10, wherein the optical information of the image and the reference light as sensed is analyzed to obtain a motion information of the scenery.
